(19) United States
(12) Patent Application Publication
(10) Pub. No.: US 2026/0290004 A1
(43) Pub. Date: Sep. 24, 2026

(54) SYSTEM FOR IDENTIFYING FAKE IMAGES GENERATED BY AI

(71) Applicant: SoftBank Group Corp., Tokyo (JP)

(72) Inventor: Keiko SUGAWA, Tokyo (JP)

(21) Appl. No.: 19/564,167

(22) Filed: Mar. 12, 2026

Related U.S. Application Data
(60) Provisional application No. 63/773,481, filed on Mar. 18, 2025.

(51) Int. Cl. G06V 10/98; G06F 16/951

(52) U.S. Cl. CPC G06V 10/993; G06F 16/951

(57) ABSTRACT

A system for monitoring unauthorized use of a specific logo image on the Internet. This system includes a crawling unit, an image determination unit, a summary generation unit, a listing unit, and a user interface. The crawling unit efficiently searches for web pages including a specific logo image by using a crawler for a search engine and making full use of specific keywords and image recognition technology. The image determination unit analyzes a collected image using AI technology and distinguishes between a genuine logo and an AI-generated fake logo. The summary generation unit collects information of a website on which an image determined to be AI-generated is posted, extracts important information, and generates a summary.

### CROSS-REFERENCE TO RELATED APPLICATIONS

This application is based upon and claims the benefit of priority from U.S. Provisional Patent Application No. 63/773,481, filed on Mar. 18, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to prevent unauthorized use of a specific logo image on the Internet. For example, an object is to prevent trademark infringement and a decline in brand image caused by fake logo images, which are easily generated due to the evolution of AI technology, being used in a form indistinguishable from genuine logos. There are a vast number of web pages on the Internet, and it is extremely difficult to manually identify unauthorizedly used logo images from among them, so an efficient monitoring means is required. Disclosed herein is to efficiently detect unauthorized use by automatically crawling a wide range of web pages using a crawler and collecting specific logo images. In addition, accurate monitoring is realized by analyzing the collected images utilizing AI technology and distinguishing between genuine logos and AI-generated fake logos. Furthermore, by summarizing and listing information on websites where images determined to be AI-generated are posted, a foundation is provided for a human operator to promptly take countermeasures. In this way, unauthorized use of a specific logo can be effectively prevented, and brand protection can be achieved.

A system for monitoring a specific image on the Internet is provided. This system includes the following main parts.

First, the system includes a crawling unit, which has a function of automatically crawling web pages on the Internet to collect a specific image. This crawling unit can efficiently search web pages and find pages including the specific image by using a crawler for a search engine and making full use of specific keywords and image recognition technology.

Next, the system includes an image determination unit, which has a function of analyzing a collected image and determining whether the image is genuine or AI-generated. This image determination unit is capable of identifying an AI-generated image by analyzing features of the image in detail using AI technology and comparing the image with a known genuine image.

Furthermore, the system includes a summary generation unit, which has a function of collecting information of a website on which an image determined to be AI-generated is posted and summarizing the information. This summary generation unit can analyze the content of the collected website, extract important information, and generate a summary.

Finally, the system includes a listing unit, which has a function of listing and displaying the summarized information and images. This listing unit can provide a foundation for a human operator to quickly check and take necessary countermeasures.

By combining these parts, a system is realized that efficiently and accurately monitors unauthorized use of a specific logo image on the Internet and enables a prompt response.

The present system does not merely replace monitoring tasks performed by humans with a computer, but provides a technical means for extracting and analyzing, in real time using specific hardware resources (such as a GPU or a TPU), image feature amounts at a level imperceptible to humans (for example, high-frequency noise or unnaturalness in pixel arrangement specific to images generated by GANs) from among vast data traffic on the Internet. Thereby, fraud detection is realized at a scale and speed that were physically impossible with conventional manual monitoring, and a specific algorithm (described later) for reducing false positives is implemented.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method of identifying a fake image on the Internet.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

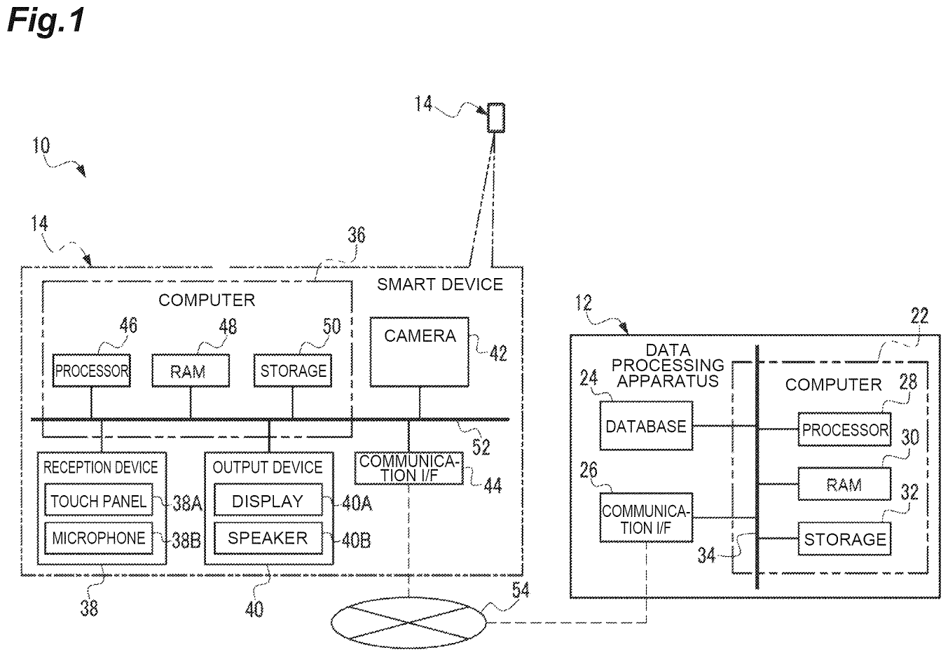

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

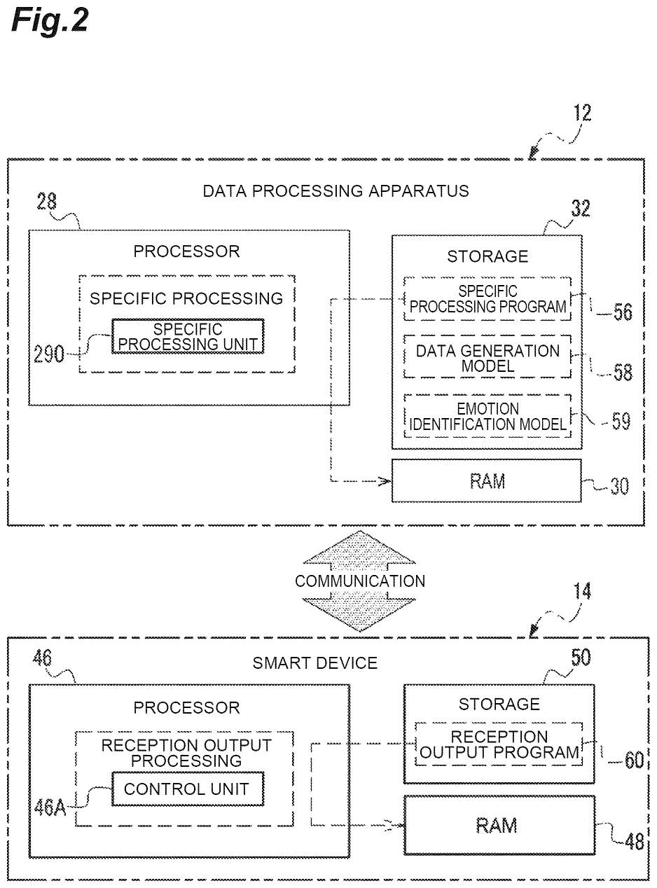

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

A system configuration using a server and a terminal will be described in more detail.

In this system, a server and a terminal operate in cooperation to monitor unauthorized use of a specific logo image on the Internet. The server mainly performs data collection, analysis, and storage, and the terminal provides a user interface and performs confirmation and operation of results.

The server-side configuration is as follows.

### 1. Crawling Unit

The crawling unit has a function for automatically crawling web pages on the Internet. This unit efficiently searches for pages including a specific logo image by using a crawler for a search engine and making full use of specific keywords and image recognition technology. For example, it uses specific brand names or related product names as keywords and preferentially crawls pages related to these. In addition, it can target images with specific color tones and shapes using image recognition technology. Furthermore, the crawler can also analyze metadata of web pages and preferentially crawl pages that are highly likely to contain images. For example, it can determine the relevance of an image based on the page title or meta tags.

The crawling unit adopts a distributed architecture, and a plurality of nodes may operate in coordination. For example, in order to analyze dynamically generated content (DOM elements rendered by JavaScript or the like), headless browser technology is used to acquire both a screenshot after rendering and source code. The crawling unit may be provided with a “Politeness” control algorithm that dynamically adjusts an access frequency in consideration of a server load of a target website. This achieves both efficient use of network bandwidth and avoidance of blocking from the monitoring target site.

### 2. Image Determination Unit

The image determination unit analyzes a collected image and determines whether the image is genuine or AI-generated. This unit analyzes features of the image in detail using AI technology and compares it with a known genuine logo. For example, it can also take into consideration the color tone, shape, and pattern of the image, as well as the image resolution and compression format. For example, it can make a determination based on the color tone and font specific to a particular brand's logo. In addition, the AI also analyzes the background and surrounding elements of the image and comprehensively determines how the logo is being used.

The image determination unit may include a model applying a discriminator of a Convolutional Neural Network (CNN) and a Generative Adversarial Network (GAN). When determining an AI-generated image, the image determination unit may perform transformation not only into a spatial domain of the image but also into a frequency domain (for example, Fast Fourier Transform: FFT) to detect a bias in a frequency spectrum (artifact) specific to the AI-generated image. This processing captures minute features that cannot be recognized by human vision, and is realized by signal processing in units of pixels. The image determination unit may calculate a cosine similarity between a feature vector of a known genuine logo and a feature vector of a collected image, and extract the image as a candidate only when the cosine similarity exceeds a predetermined threshold (for example, 0.95), thereby preventing waste of computational resources.

### 3. Summary Generation Unit

The summary generation unit collects information of a website on which an image determined to be AI-generated is posted and summarizes the information. This unit analyzes the content of the collected website, extracts important information, and generates a summary. For example, based on the page title, main headings, and image captions, it can concisely indicate how the image is being used. In addition, the summary generation unit can also analyze the content of the page using natural language processing technology to understand the purpose of use and context of the image.

The summary generation unit utilizes a Transformer-based natural language processing model (for example, BERT or GPT architecture) and may have an “attention mechanism” that intensively extracts a context around an image (sentences before and after, alt attributes, meta tags) from text data in a website. The summary generation unit may perform sentiment analysis on the extracted text and score whether the site is positive or negative regarding the brand, or whether there is a high possibility that the site contains fraudulent intent (phishing or the like). This score may be used for prioritization in the listing unit described later.

### 4. Listing Unit

The listing unit lists and stores the summarized information and images. This list is used for confirmation work on the terminal side, which will be described later. The listing unit can organize the information by category and, for example, assign priorities based on the image determination results and the reliability of the website. Furthermore, the listing unit can visually organize the information so that an operator can quickly access it, and can, for example, display image thumbnails or display summary information in a pop-up.

The listing unit may have a function of recording the collected image data and a hash value of the website using blockchain technology or a Time Stamp Authority (TSA) in order to preserve evidence of the determined unauthorized use. Thereby, even after the website is deleted, legal evidentiary capacity can be maintained. The listing unit may be provided with an automation module that automatically generates a “Takedown Notice” based on a confidence score of a determination result and a maliciousness score of the site (calculated from a domain age, presence or absence of an SSL certificate, etc.) and transmits the Takedown Notice to a hosting provider of the target site via an API.

The crawling unit, the image determination unit, the summary generation unit, and the listing unit may be configured by, for example, the computer 22 (the processor 28 or the like) of the data processing apparatus 12, or may be configured by the specific processing unit 290, the specific processing program 56, the data generation model 58, and the like.

The terminal-side configuration is as follows.

### 1. User Interface

A user interface is implemented on the terminal, and an operator can check a list transmitted from the server and take necessary countermeasures. This interface is designed to visually display the listed information so that the operator can make a quick judgment. For example, it can display image thumbnails or display summary information in a pop-up. In addition, the operator can also send feedback to the server through the terminal and contribute to improving the accuracy of the system. Furthermore, the user interface is provided with a function for the operator to add comments to a specific image or website, or to record the response status.

In this way, a system is realized that efficiently and accurately monitors unauthorized use of a specific logo image on the Internet and enables a prompt response by the server and the terminal cooperating. This system serves as a powerful tool for preventing unauthorized use of a specific logo and for achieving brand protection.

### (System Configuration)

The system includes a crawling unit, an image determination unit, a summary generation unit, a listing unit, and a user interface. The crawling unit has a function of automatically crawling web pages on the Internet and collecting a specific logo image. This unit efficiently searches for pages including a specific logo image by using a crawler for a search engine and making full use of specific keywords and image recognition technology. For example, it uses specific brand names or related product names as keywords and preferentially crawls pages related to these. In addition, it can target images with specific color tones and shapes using image recognition technology. Furthermore, the crawler can also analyze metadata of web pages and preferentially crawl pages that are highly likely to contain images. For example, it can determine the relevance of an image based on the page title or meta tags.

The image determination unit analyzes a collected image and determines whether the image is genuine or AI-generated. This unit analyzes features of the image in detail using AI technology and compares it with a known genuine logo. For example, it can also take into consideration the color tone, shape, and pattern of the image, as well as the image resolution and compression format. For example, it can make a determination based on the color tone and font specific to a particular brand's logo. In addition, the AI also analyzes the background and surrounding elements of the image and comprehensively determines how the logo is being used. Furthermore, the AI can also magnify a part of the image to check details and detect minute features.

The summary generation unit collects information of a website on which an image determined to be AI-generated is posted and summarizes the information. This unit analyzes the content of the collected website, extracts important information, and generates a summary. For example, based on the page title, main headings, and image captions, it can concisely indicate how the image is being used. In addition, the summary generation unit can also analyze the content of the page using natural language processing technology to understand the purpose of use and context of the image. Furthermore, the summary generation unit can also integrate information from multiple pages to grasp overall trends and patterns.

The listing unit lists and stores the summarized information and images. This list is used for confirmation work in a user interface to be described later. The listing unit can organize the information by category and, for example, assign priorities based on the image determination results and the reliability of the website. Furthermore, the listing unit can visually organize the information so that an operator can quickly access it, and can, for example, display image thumbnails or display summary information in a pop-up. In addition, the listing unit is also provided with a function to detect new trends by comparing with past data.

The user interface allows an operator to check a list transmitted from the server and take necessary countermeasures. This interface is designed to visually display the listed information so that the operator can make a quick judgment. For example, it can display image thumbnails or display summary information in a pop-up. In addition, the operator can also send feedback to the server through the terminal and contribute to improving the accuracy of the system. Furthermore, the user interface is provided with a function for the operator to add comments to a specific image or website, or to record the response status.

Specific examples of prompt sentences to be read into a generative AI include “Please determine whether this image is a logo of a specific brand.” and “Please summarize the content of this web page and clarify the purpose of use of the image.”. These prompt sentences function as instructions for the AI to accurately analyze the image and understand the content of the web page.

### (Implementation Steps)

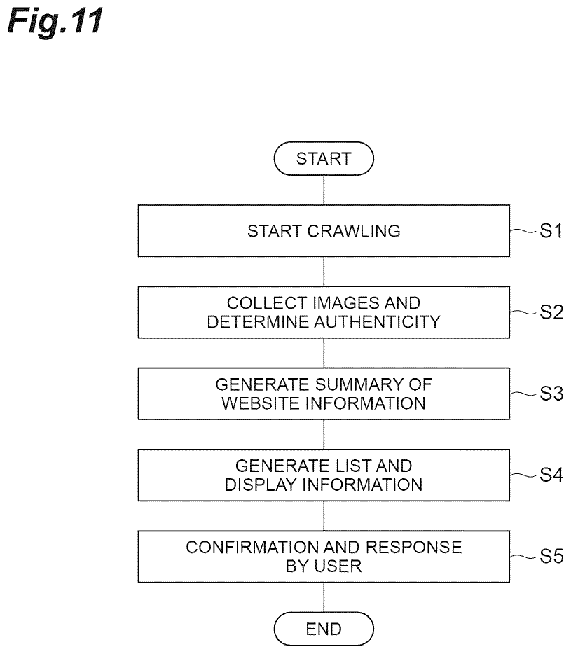

### Step 1: Start of Crawling (Refer to Step S1 of FIG. 11)

The system first activates the crawling unit and automatically crawls web pages on the Internet. In this step, a crawler for a search engine is used to efficiently search for pages including a specific logo image by making full use of specific keywords and image recognition technology. For example, specific brand names or related product names are used as keywords, and pages related to these are preferentially crawled. In addition, images with specific color tones and shapes can be targeted using image recognition technology. Furthermore, the crawler can also analyze metadata of web pages and preferentially crawl pages that are highly likely to contain images.

### Step 2: Image Collection and Determination (Refer to Step S2 of FIG. 11)

The collected image is analyzed by the image determination unit. In this step, features of the image are analyzed in detail using AI technology and compared with a known genuine logo. For example, the color tone, shape, and pattern of the image, as well as the image resolution and compression format, can also be taken into consideration. For example, a determination can be made based on the color tone and font specific to a particular brand's logo. In addition, the AI also analyzes the background and surrounding elements of the image and comprehensively determines how the logo is being used. A specific example of a prompt sentence to be read into the generative AI is “Please determine whether this image is a logo of a specific brand.”.

### Step 3: Summary Generation of Website Information (Refer to Step S3 of FIG. 11)

Information of a website on which an image determined to be AI-generated is posted is collected and summarized by the summary generation unit. In this step, the content of the collected website is analyzed, and important information is extracted to generate a summary. For example, based on the page title, main headings, and image captions, it can be concisely indicated how the image is being used. In addition, the summary generation unit can also analyze the content of the page using natural language processing technology to understand the purpose of use and context of the image. A specific example of a prompt sentence to be read into the generative AI is “Please summarize the content of this web page and clarify the purpose of use of the image.”

### Step 4: Listing and Display of Information (Refer to Step S4 of FIG. 11)

The summarized information and images are listed and stored by the listing unit. In this step, the information can be organized by category, and priorities can be assigned based on, for example, the image determination results and the reliability of the website. Furthermore, the listing unit can visually organize the information so that an operator can quickly access it, and can, for example, display image thumbnails or display summary information in a pop-up. In addition, the listing unit is also provided with a function to detect new trends by comparing with past data.

### Step 5: Confirmation and Response by User (Refer to Step S5 of FIG. 11)

Finally, through the user interface, an operator checks the list transmitted from the server and takes necessary countermeasures. In this step, the listed information is visually displayed, and it is designed so that the operator can make a quick judgment. For example, image thumbnails or pop-up displays of summary information can be performed. In addition, the operator can also send feedback to the server through the terminal and contribute to improving the accuracy of the system. Furthermore, the user interface is provided with a function for the operator to add comments to a specific image or website, or to record the response status.

### (Specific Use Case)

For example, when a specific brand needs to monitor whether its logo is being used unauthorizedly on the Internet, the system can be used. This system first uses the crawling unit to automatically crawl a wide range of web pages on the Internet and collect a specific logo image. The crawler uses brand names and related product names as keywords and preferentially searches for pages related to these. In addition, it can target images with specific color tones and shapes by making full use of image recognition technology. For example, it is possible to efficiently detect a logo with a specific color tone or a logo using a specific font.

The collected image is analyzed by the image determination unit. This unit analyzes features of the image in detail using AI technology and compares it with a known genuine logo. For example, the color tone, shape, and pattern of the image, as well as the image resolution and compression format, can also be taken into consideration. For example, a determination can be made based on the color tone and font specific to a particular brand's logo. A specific example of a prompt sentence to be read into the generative AI is “Please determine whether this image is a logo of a specific brand.”.

Information of a website on which an image determined to be AI-generated is posted is collected and summarized by the summary generation unit. This unit analyzes the content of the collected website, extracts important information, and generates a summary. For example, based on the page title, main headings, and image captions, it can be concisely indicated how the image is being used. In addition, the summary generation unit can also analyze the content of the page using natural language processing technology to understand the purpose of use and context of the image. A specific example of a prompt sentence to be read into the generative AI is “Please summarize the content of this web page and clarify the purpose of use of the image.”.

The summarized information and images are listed and stored by the listing unit. This list can organize the information by category and, for example, assign priorities based on the image determination results and the reliability of the website. Furthermore, the listing unit can visually organize the information so that an operator can quickly access it, and can, for example, display image thumbnails or display summary information in a pop-up.

Finally, through the user interface, an operator checks the list transmitted from the server and takes necessary countermeasures. This interface is designed to visually display the listed information so that the operator can make a quick judgment. For example, image thumbnails or pop-up displays of summary information can be performed. In addition, the operator can also send feedback to the server through the terminal and contribute to improving the accuracy of the system. Furthermore, the user interface is provided with a function for the operator to add comments to a specific image or website, or to record the response status.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

This system is for monitoring unauthorized content and false information on the Internet and responding promptly, and includes a crawling unit, an information determination unit, a summary generation unit, a listing unit, and a user interface.

First, the crawling unit automatically crawls a wide range of web pages on the Internet. This unit has a function of collecting pages including a specific keyword or phrase. For example, it uses specific company names, personal names, product names, event names, and the like as keywords and preferentially searches for pages related to these. The crawling unit can also perform a search limited to a specific domain or region by using an API of a search engine. Furthermore, the crawler can also analyze metadata of web pages and preferentially crawl pages that are highly likely to contain information. For example, it can determine the relevance of information based on the page title or meta tags. In addition, the crawler is also provided with a function to preferentially crawl pages with high importance based on the update frequency and number of accesses of the page.

Next, the information determination unit analyzes the collected information and determines whether the information is accurate or false information. This unit evaluates the reliability of the information using AI technology and compares it with a known reliable information source. For example, it determines whether the source of the information is an official news site or a personal blog and evaluates the reliability. In addition, a determination can be made based on the frequency with which the information is cited, the consistency of the content of the information, and the consistency with past data. The information determination unit can also analyze the content of the information in detail and understand the context using natural language processing technology. For example, it can determine whether the information is related to a specific event or whether it includes expressions that may cause misunderstanding. Furthermore, the information determination unit is also provided with a function to quantify the reliability of the information so that an operator can easily make a judgment. For example, it can visually display the reliability of the information using a reliability score.

The summary generation unit collects the content of a website on which information determined to be false information is posted and summarizes the information. This unit analyzes the content of the collected website, extracts important information, and generates a summary. For example, based on the page title, main headings, and key points of the information, it can be concisely indicated how the information is being used. The summary generation unit analyzes the content of the page to understand the purpose of use and context of the information using natural language processing technology. For example, it can determine whether the information is being spread with a specific intention or whether it includes expressions that may cause misunderstanding. Furthermore, the summary generation unit can also integrate information from multiple pages to grasp overall trends and patterns. For example, it can show how the same false information is being spread on multiple sites.

The listing unit lists and stores the summarized information. This list can organize the information by category and, for example, assign priorities based on the reliability and impact of the information. The listing unit can visually organize the information so that an operator can quickly access it, and can, for example, display a summary of the information or display a reliability evaluation in a pop-up. In addition, the listing unit is also provided with a function to detect new trends by comparing with past data. For example, if specific false information is spreading rapidly, that trend can be detected early and a warning can be issued. Furthermore, the listing unit is also provided with a function to track the history of information and record past countermeasures and results. This allows the operator to take more effective countermeasures based on past data.

Finally, the user interface allows an operator to check the list transmitted from the server and take necessary countermeasures. This interface is designed to visually display the listed information so that the operator can make a quick judgment. For example, a summary of the information or a pop-up display of a reliability evaluation can be performed. The user interface is provided with a function for the operator to add comments to specific information or a website, or to record the response status. This allows the operator to evaluate the reliability of the information and take appropriate action promptly. In addition, the user interface can also allow the operator to send feedback to the system and contribute to improving the accuracy of the system. For example, feedback on misjudged information can be sent to help improve the AI model.

### (System Configuration)

The system includes a crawling unit, an information determination unit, a summary generation unit, a listing unit, and a user interface. The crawling unit has a function of automatically crawling a wide range of web pages on the Internet and collecting pages including a specific keyword or phrase. This unit uses specific company names, personal names, product names, event names, and the like as keywords and preferentially searches for pages related to these. For example, it can target news articles about a specific company or review articles about a product. Furthermore, the crawler can also analyze metadata of web pages and preferentially crawl pages that are highly likely to contain information. For example, it can determine the relevance of information based on the page title or meta tags. In addition, the crawler is also provided with a function to preferentially crawl pages with high importance based on the update frequency and number of accesses of the page. A specific example of a prompt sentence to be read into a generative AI is “Please collect pages including a specific keyword.”.

The information determination unit analyzes the collected information and determines whether the information is accurate or false information. This unit evaluates the reliability of the information using AI technology and compares it with a known reliable information source. For example, it determines whether the source of the information is an official news site or a personal blog and evaluates the reliability. In addition, a determination can be made based on the frequency with which the information is cited, the consistency of the content of the information, and the consistency with past data. The information determination unit can also analyze the content of the information in detail and understand the context using natural language processing technology. For example, it can determine whether the information is related to a specific event or whether it includes expressions that may cause misunderstanding. Furthermore, the information determination unit is also provided with a function to quantify the reliability of the information so that an operator can easily make a judgment. For example, it can visually display the reliability of the information using a reliability score. A specific example of a prompt sentence to be read into a generative AI is “Please determine whether this information is reliable.”.

The summary generation unit collects the content of a website on which information determined to be false information is posted and summarizes the information. This unit analyzes the content of the collected website, extracts important information, and generates a summary. For example, based on the page title, main headings, and key points of the information, it can be concisely indicated how the information is being used. The summary generation unit analyzes the content of the page to understand the purpose of use and context of the information using natural language processing technology. For example, it can determine whether the information is being spread with a specific intention or whether it includes expressions that may cause misunderstanding. Furthermore, the summary generation unit can also integrate information from multiple pages to grasp overall trends and patterns. For example, it can show how the same false information is being spread on multiple sites. A specific example of a prompt sentence to be read into a generative AI is “Please summarize the content of this web page and clarify the purpose of use of the information.”.

The listing unit lists and stores the summarized information. This list can organize the information by category and, for example, assign priorities based on the reliability and impact of the information. The listing unit can visually organize the information so that an operator can quickly access it, and can, for example, display a summary of the information or display a reliability evaluation in a pop-up. In addition, the listing unit is also provided with a function to detect new trends by comparing with past data. For example, if specific false information is spreading rapidly, that trend can be detected early and a warning can be issued. Furthermore, the listing unit is also provided with a function to track the history of information and record past countermeasures and results. This allows the operator to take more effective countermeasures based on past data.

The user interface allows an operator to check the list transmitted from the server and take necessary countermeasures. This interface is designed to visually display the listed information so that the operator can make a quick judgment. For example, a summary of the information or a pop-up display of a reliability evaluation can be performed. The user interface is provided with a function for the operator to add comments to specific information or a website, or to record the response status. This allows the operator to evaluate the reliability of the information and take appropriate action promptly. In addition, the user interface can also allow the operator to send feedback to the system and contribute to improving the accuracy of the system. For example, feedback on misjudged information can be sent to help improve the AI model.

### (Implementation Steps)

### Step 1: Start of Crawling

The system first activates the crawling unit and automatically crawls a wide range of web pages on the Internet. In this step, specific company names, personal names, product names, event names, and the like are used as keywords to collect pages including a specific keyword or phrase. The crawling unit can also perform a search limited to a specific domain or region by using an API of a search engine. Furthermore, the crawler can also analyze metadata of web pages and preferentially crawl pages that are highly likely to contain information. For example, it can determine the relevance of information based on the page title or meta tags. In addition, the crawler is also provided with a function to preferentially crawl pages with high importance based on the update frequency and number of accesses of the page.

### Step 2: Information Collection and Determination

The collected information is analyzed by the information determination unit. In this step, the reliability of the information is evaluated using AI technology and compared with a known reliable information source. For example, it determines whether the source of the information is an official news site or a personal blog and evaluates the reliability. In addition, a determination can be made based on the frequency with which the information is cited, the consistency of the content of the information, and the consistency with past data. The information determination unit can also analyze the content of the information in detail and understand the context using natural language processing technology. A specific example of a prompt sentence to be read into a generative AI is “Please determine whether this information is reliable.”.

### Step 3: Information Summary Generation

The content of a website on which information determined to be false information by the information determination unit is posted is collected and summarized by the summary generation unit. In this step, the content of the collected website is analyzed, and important information is extracted to generate a summary. For example, based on the page title, main headings, and key points of the information, it can be concisely indicated how the information is being used. The summary generation unit analyzes the content of the page to understand the purpose of use and context of the information using natural language processing technology. A specific example of a prompt sentence to be read into a generative AI is “Please summarize the content of this web page and clarify the purpose of use of the information.”.

### Step 4: Listing and Display of Information

The summarized information is listed and stored by the listing unit. In this step, the information can be organized by category, and priorities can be assigned based on, for example, the reliability and impact of the information. The listing unit can visually organize the information so that an operator can quickly access it, and can, for example, display a summary of the information or display a reliability evaluation in a pop-up. In addition, the listing unit is also provided with a function to detect new trends by comparing with past data.

### Step 5: Confirmation and Response by User

Finally, through the user interface, an operator checks the list transmitted from the server and takes necessary countermeasures. In this step, the listed information is visually displayed, and it is designed so that the operator can make a quick judgment. For example, a summary of the information or a pop-up display of a reliability evaluation can be performed. In addition, the operator can also send feedback to the server through the terminal and contribute to improving the accuracy of the system. Furthermore, the user interface is provided with a function for the operator to add comments to specific information or a website, or to record the response status.

### (Specific Use Case)

For example, if a certain company wants to prevent the spread of false information on the Internet to protect its brand image, the system can be utilized. This company is concerned about the spread of false information including specific product names or campaign names, and needs to detect this early and take appropriate action.

This system first uses the crawling unit to automatically crawl a wide range of web pages on the Internet and collect pages including a specific keyword or phrase. For example, it sets company names, product names, and campaign names as keywords and preferentially searches for pages related to these. The crawler can also perform a search limited to a specific domain or region by using an API of a search engine. Furthermore, it can also analyze metadata of web pages and preferentially crawl pages that are highly likely to contain information.

The collected information is analyzed by the information determination unit. This unit evaluates the reliability of the information using AI technology and compares it with a known reliable information source. For example, it determines whether the source of the information is an official news site or a personal blog and evaluates the reliability. In addition, a determination can be made based on the frequency with which the information is cited, the consistency of the content of the information, and the consistency with past data. A specific example of a prompt sentence to be read into a generative AI is “Please determine whether this information is reliable.”.

The content of a website on which information determined to be false information by the information determination unit is posted is collected and summarized by the summary generation unit. This unit analyzes the content of the collected website, extracts important information, and generates a summary. For example, based on the page title, main headings, and key points of the information, it can be concisely indicated how the information is being used. A specific example of a prompt sentence to be read into a generative AI is “Please summarize the content of this web page and clarify the purpose of use of the information.”.

The summarized information is listed and stored by the listing unit. This list can organize the information by category and, for example, assign priorities based on the reliability and impact of the information. The listing unit can visually organize the information so that an operator can quickly access it, and can, for example, display a summary of the information or display a reliability evaluation in a pop-up.

Finally, through the user interface, an operator checks the list transmitted from the server and takes necessary countermeasures. This interface is designed to visually display the listed information so that the operator can make a quick judgment. For example, a summary of the information or a pop-up display of a reliability evaluation can be performed. In addition, the operator can also send feedback to the server through the terminal and contribute to improving the accuracy of the system. Furthermore, the user interface is provided with a function for the operator to add comments to specific information or a website, or to record the response status. This allows the company to effectively monitor the spread of false information and respond promptly.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

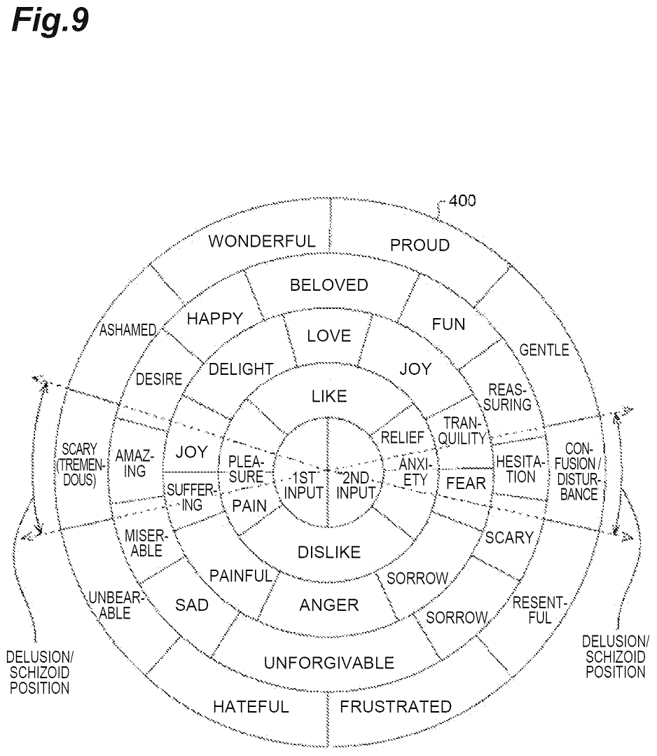

The specific processing unit 290 in the present system may monitor a biological reaction or an emotion state of an operator (user) using the above-described emotion identification model 59. For example, when the operator shows a specific emotion such as “surprise” or “anger” (a high arousal/unpleasant region in the emotion map of FIG. 9 described later) when checking the listed unauthorized images, the system may re-tag the image as “high priority” and feed it back to the data generation model 58 as learning data. Thereby, “Human-in-the-loop” type reinforcement learning that utilizes human intuitive judgment for AI re-learning and dynamically improves the next detection accuracy (Precision/Recall) can be realized.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

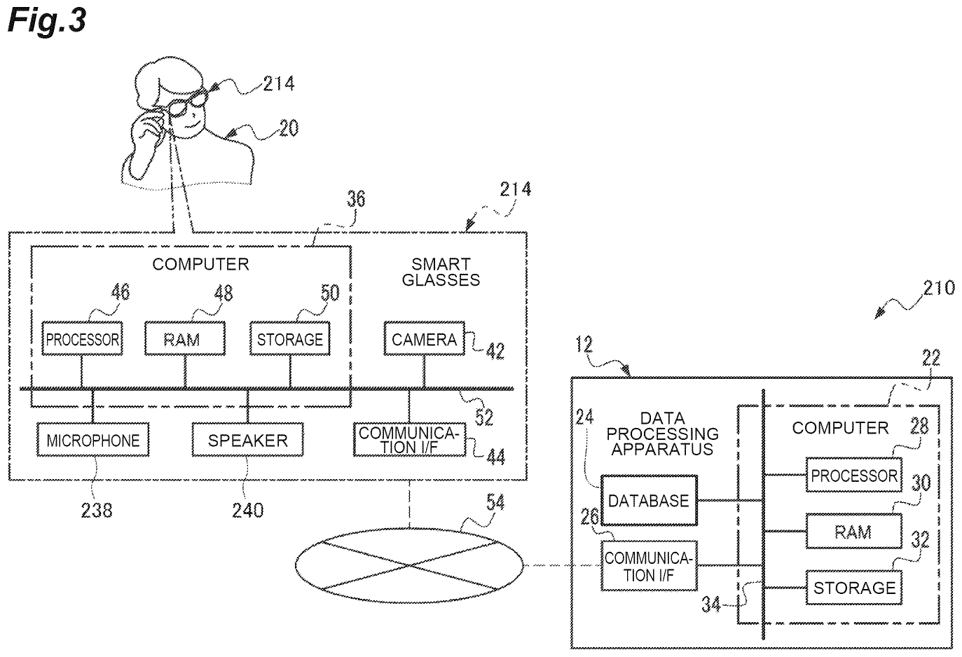

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

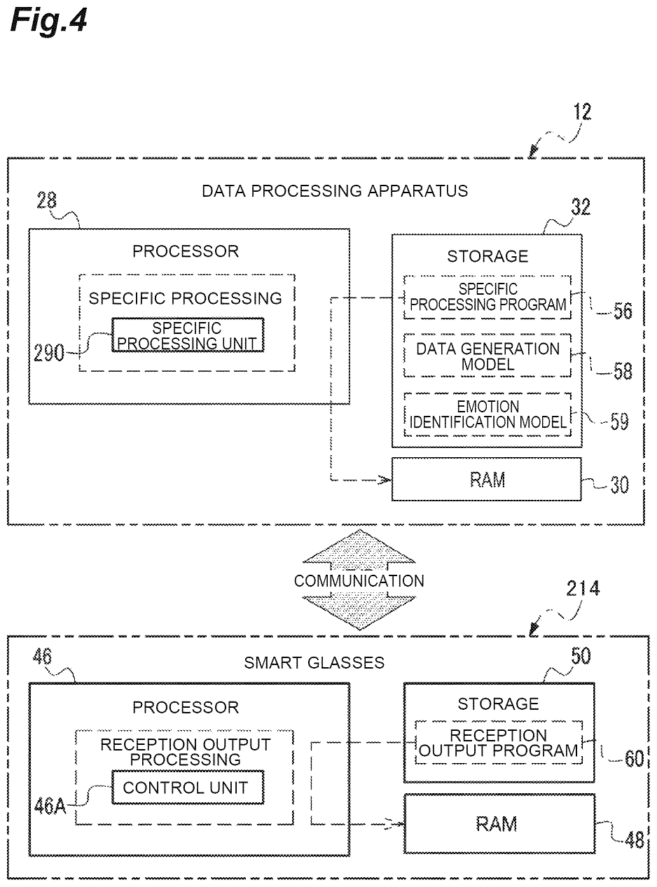

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

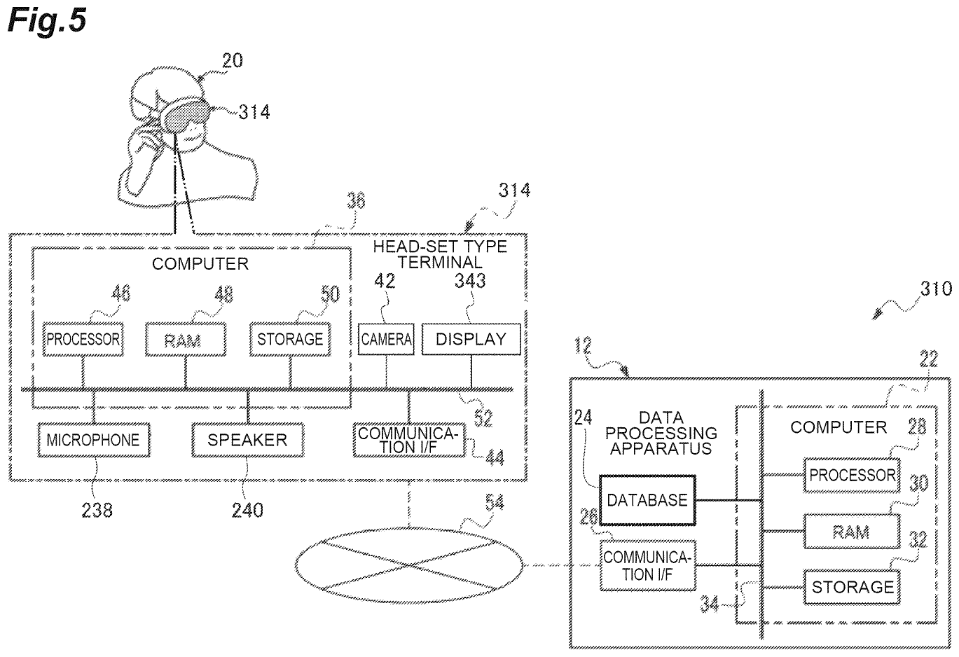

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

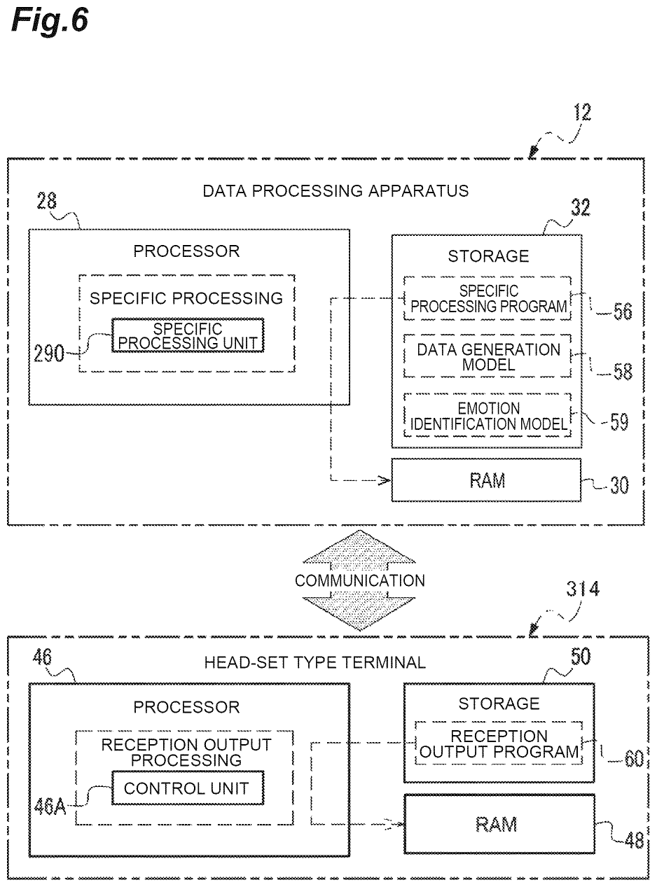

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

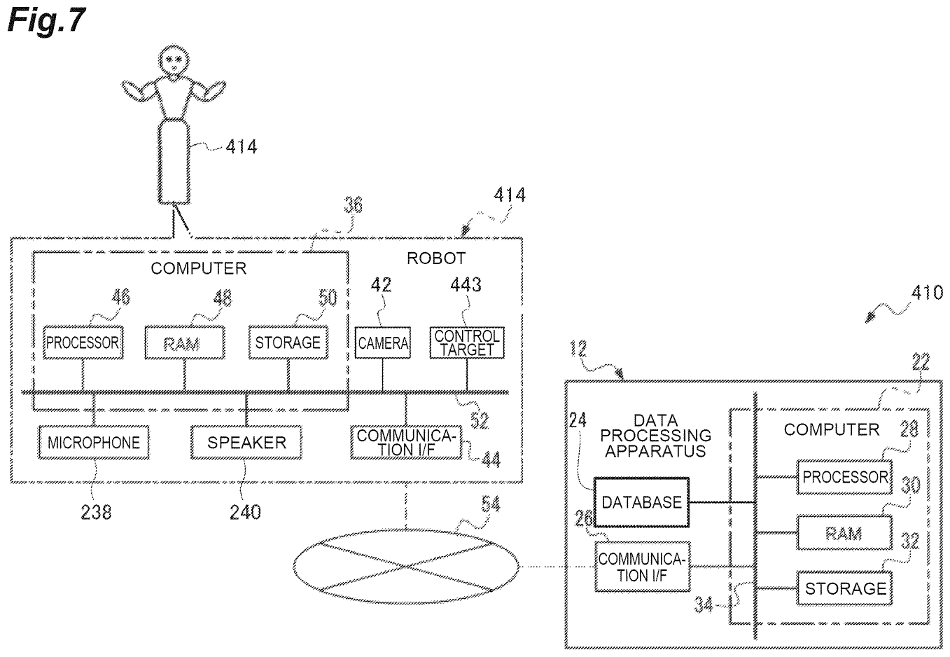

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

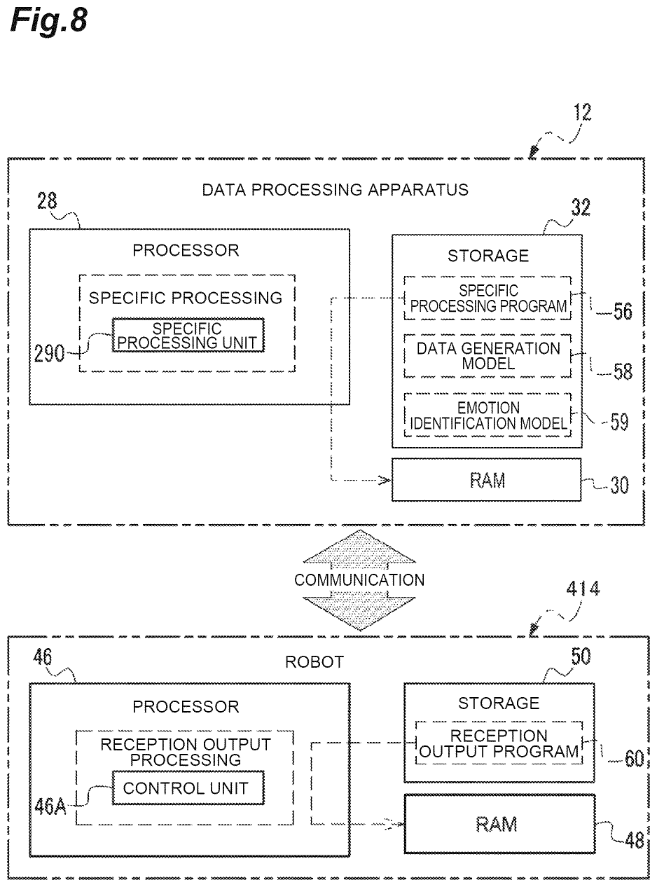

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

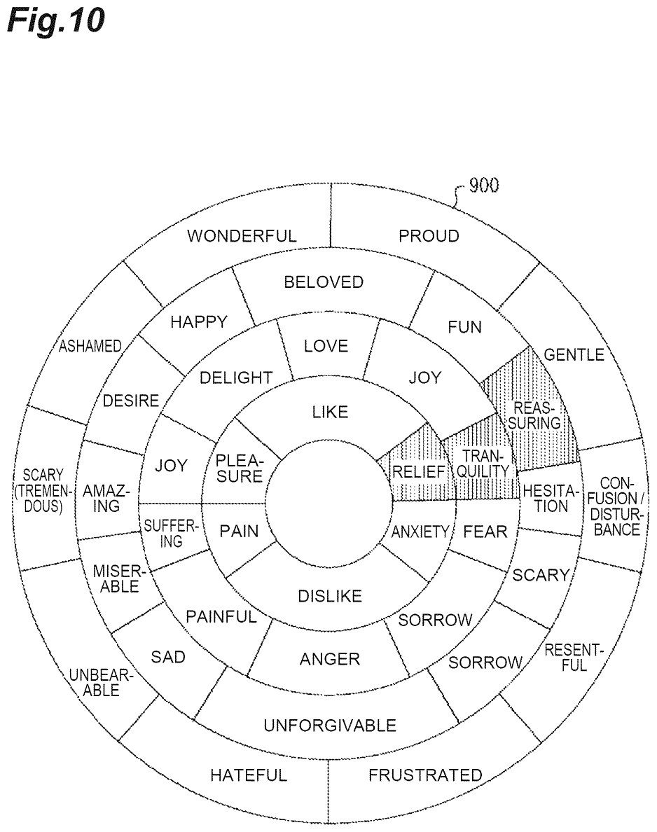

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a crawling unit, an information determination unit, and a summary generation unit, wherein the crawling unit has a function of automatically crawling web pages on the Internet and collecting pages including a specific keyword or phrase, the information determination unit has a function of analyzing collected information and determining whether the information is accurate or false information, and the summary generation unit has a function of collecting content of a website on which information determined to be false information is posted and summarizing the information.

In some examples, the crawling unit has a function of preferentially searching for pages related to specific company names, personal names, product names, event names, and the like used as keywords, and further has a function of analyzing content of a page using natural language processing technology and extracting information related to a specific context.

In some examples, the information determination unit has a function of evaluating reliability of information using AI technology and comparing it with a known reliable information source, and has a function of making a determination based on a source of the information, a citation frequency, consistency of content, and consistency with past data, and the summary generation unit has a function of generating a summary indicating how the information is being used based on a page title, main headings, and key points of the information.

An example system for identifying a fake image generated by AI may include circuitry. The circuitry may be configured to: crawl web pages on the Internet to collect an image; analyze the collected image to determine whether the image is a genuine image or the fake image generated by AI; collect information of a website on which the fake image is posted and summarize the information; and list the summarized information and the fake image.

In some examples, collecting the image may include finding a page including a specific image by crawling web pages on the Internet using a crawler for a search engine based on a specific keyword and image recognition technology.

In some examples, analyzing the collected image may include identifying the fake image generated by AI by analyzing a feature of the collected image and comparing the collected image with the known genuine image.

In some examples, summarizing the information may include analyzing content of the collected website, extracting important information, and generating a summary.

An example method of identifying a fake image generated by AI may include: crawling web pages on the Internet to collect an image; analyzing the collected image to determine whether the image is a genuine image or the fake image generated by AI; collecting information of a website on which the fake image is posted and summarizing the information; and listing the summarized information and the fake image.

What is claimed is:

1. A system for identifying a fake image generated by AI, the system comprising circuitry:
wherein the circuitry is configured to:
crawl web pages on the Internet to collect an image;
analyze the collected image to determine whether the image is a genuine image or the fake image generated by AI;
collect information of a website on which the fake image is posted and summarize the information; and
list the summarized information and the fake image.

2. The system according to claim 1, wherein collecting the image includes finding a page including a specific image by crawling web pages on the Internet using a crawler for a search engine based on a specific keyword and image recognition technology.

3. The system according to claim 1, wherein analyzing the collected image includes identifying the fake image generated by AI by analyzing a feature of the collected image and comparing the collected image with the known genuine image.

4. The system according to claim 1, wherein summarizing the information includes analyzing content of the collected website, extracting important information, and generating a summary.

5. A method of identifying a fake image generated by AI, the method comprising:
crawling web pages on the Internet to collect an image;
analyzing the collected image to determine whether the image is a genuine image or the fake image generated by AI;
collecting information of a website on which the fake image is posted and summarizing the information; and
listing the summarized information and the fake image.
